(19) United States
(12) Patent Application Publication
(10) Pub. No.: US 2005/0172232 A1
(43) Pub. Date: Aug. 4, 2005

(54) Synchronisation in multi-modal interfaces

(76) Inventor: Richard M Wiseman, Kesgrave (GB)

Correspondence Address: NIXON & VANDERHYE, PC, 901 NORTH GLEBE ROAD, 11TH FLOOR, ARLINGTON, VA, 22203, US

(21) Appl. No.: 10/509,084

(22) PCT Filed: Mar. 28, 2003
(86) PCT No.: PCT/GB03/01391

(30) Foreign Application Priority Data
Mar. 28, 2002 (EP) 02252313.8

(51) Int. Cl. G11B 27/00; G06F 3/00; G06F 17/30; G06F 17/00; G06F 1/12

(52) U.S. Cl. 715/718; 713/401; 715/717; 715/716; 715/727; 715/728; 715/729; 715/720; 715/831; 715/851; 715/766; 707/200; 707/10

(57) ABSTRACT

A method of synchronising the delivery to a user of first information which is to be presented to the user via a visual display of a multi-modal interface and of second information which is to be presented to the user over a visual or an audio interface of the multi-modal interface, in which the multi-modal interface process estimates the total time needed to deliver the first information to the visual display or to a store local to the visual display, estimates the total time needed to deliver the second information to the visual or audio interface or to a store local to the visual or audio interface; and then uses the estimates to determine whether the presentation to the user of the first or second information to the user needs to be delayed to achieve a desired synchronism of presentation; and then applies any delay determined to be necessary to achieve the desired synchronism of presentation.

This invention relates to a method of synchronising the delivery to a user of content in a multi-modal interface and system which implements the method. In particular, but not exclusively, the invention concerns a method and system for synchronising delivery of visual and audible information in a multi-modal interface.

A multi-modal interface is a type of man-machine interface in which: (i) a user is either presented with information in two or more modes, for example visual information presented on a display and audible information, which may be spoken, presented audibly; and/or a user may provide input in two or more modes, for example a spoken input and a physical (motor) input (such as operation of a keyboard, or the operation of a cursor control device such as a mouse or track ball). Commonly, multi-modal interfaces are multi-modal both for the presentation of information to a user and for the receipt of information from a user. The present invention is applicable to multi-modal interfaces which are multi-modal for the presentation of information to a user, whether or not the interface is also multi-modal for the receipt of information from the user.

Some multi-modal interfaces have been designed for use on self-contained machines, such as desk-top computers, which contain a processor which operates the multi-modal interface and which ensures that information to be presented visually and information to be presented audibly are delivered to the user in the correct sequence and with appropriate timings. So, for example, a voice prompt to “select your preferred hotel from the list on the screen” is not provided until the processor knows that the appropriate list of hotels has been displayed on the machine's display. Such control is a trivial matter when the controlling process is on the same machine as the presentation devices or when the process which runs the multi-modal interface effectively has direct control of the systems which retrieve the stored information and present it to the user. This applies whether or not the information which needs to be presented to the user is all stored on the self-contained machine, since the controlling process could easily pre-emptively download content files if they were not local.

In other multi-modal interfaces the controlling process and the presentation devices are remote from each other, the latter not necessarily under the control of the former. Often the information needed for each of the different output modes is stored separately and different processes or communications paths are used for the retrieval of the stored information. Additionally, the multi-modal interface may be provided by more than one user terminal, for example a visual element may be provided by a computer or PDA and the audible element may be provided over a telephone (fixed-line or mobile). In all these situations it can be very difficult to ensure that the multi-modal interface operates correctly. In particular, if information which is presented visually and that which is presented audibly are presented in a unsynchronised manner, the user will become confused and the interface will operate less well than a uni-modal interface.

The present invention seeks to address such problems.

WO99/44363 describes methods for synchronising sound and images in a real-time multimedia communication, such as an audio-video telephone call, through a network gateway, when the source and/or the destination of the audio signals, and optionally also the video signals, is from and/or to separate audio and video communication devices. It is explained that internal processing delays in the gateway can give rise to a lack of synchronisation between sound and video signals passing through the gateway. The gateway delay may be due, for example, to the need to translate an audio signal from one standard used for transmission to the gateway input to a different standard for onward transmission from the gateway output. It is explained that it is usual to transcode the audio signals passing through a gateway, but less usual to transcode video signals. This can give rise to the audio signals experiencing delays which are not experienced by video signals which happen also to pass through the gateway. It is further explained that the audio and video signals may become further de-synchronised by the transit delay (ie propagation delay) between the gateway and the audio and video devices at the receiver. The term “synchronisation delay” is used in this reference to describe the total net difference between the audio and video signal delays, including delays through the gateway. The expression “sensory output delay” is used to define the time difference between the audio and video which the user perceives at the receiving terminal. It is suggested that the variable sensory output delay may be reduced if the magnitude of the actual delay is measured and then this measured value is used to delay the video or audio signal appropriately. In order to achieve this it is suggested that a user of the terminal gives feedback, for example using DTMF signalling to adjust the operation of the gateway until synchronisation is perceived by the user to exist between the speech and video signals. Once this variable sensory output delay has been determined, it is said to be possible to accommodate for a delay, referred to as intrinsic device transmission delay, (commonly referred to as skew) which arises from encoding delays within a device prior to transmission of the encoded signal to the gateway. This accommodation may be accomplished by looping back the signals from the separate devices to the gateway, then detecting any mismatch in the synchronisation between the looped back signals (audio and video) from the separate devices at the gateway caused by intrinsic device transmission delay and then adjusting a delay (the variable device transmission delay) in the gateway so that the looped back signals at the gateway are effectively synchronised. Optionally, a synchronisation marker is provided in the audio and video signals to facilitate the automatic detection of any mismatch in the synchronisation between the looped back signals. Overall, WO99/44363 relies very largely on calibration of various terminal types and transmission link types, together with calibration of the gateway itself as well as the use of marker pulses in the data streams. Moreover, more practical versions of the synchronisation method all rely upon user feedback to control the perceived synchronisation. While this may be a plausible approach whether there is effectively a need for lip synchronisation, for example when the system is used in a video telephony link, it is harder to see how this might usefully be used in a multi-modal interface situation.

In a first aspect the invention provides a method of synchronising the delivery to a user of first information which is to be presented to the user via first output means of a multi-modal interface and of second information which is to be presented to the user via second output means of the multi-modal interface, the method comprising the steps of:

i) estimating the total time needed to deliver the first information to the first output means or to a store local to the first output means;

ii) estimating the total time needed to deliver the second information to the second output means or to a store local to the second output means; and

iii) using the estimates obtained in step i) or step ii) to determine whether the presentation to the user of the first or second information to the user needs to be delayed to achieve a desired synchronism of presentation; and

iv) applying any delay determined in step iii) to achieved the desired synchronism of presentation.

In a second aspect the invention provides a method of synchronising the delivery to a user of first information which is to be presented to the user via a visual display of a multi-modal interface and of second information which is to be presented to the user over a visual or an audio interface of the multi-modal interface, the method comprising the steps of:

i) estimating the total time needed to deliver the first information to the visual display or to a store local to the visual display;

ii) estimating the total time needed to deliver the second information to the visual or audio interface or to a store local to the visual or audio interface; and

iii) using the estimates obtained in step i) or step ii) to determine whether the presentation to the user of the first or second information to the user needs to be delayed to achieve a desired synchronism of presentation; and

iv) applying any delay determined in step iii) to achieved the desired synchronism of presentation.

In a third aspect the invention provides a method of synchronising the delivery to a user of first information which is to be presented to the user via a visual display and of second information which is to be presented to the user over an audio interface, the method comprising the steps of:

(i) estimating the total time needed to deliver the first information to the visual display or to a store local to the visual display;

(ii) estimating the total time needed to delivery the second information to the audio interface or to a store local to the audio interface; and

(iii) if the total time estimated in step (i) is more than that estimated in step (ii) delaying the presentation of the second information to the user sufficiently to enable the first information to be presented to the user before the second information is presented to the user.

In a fourth aspect the invention provides a system of apparatus for the delivery to a user of first information which is to be presented to the user via first output means of a multi-modal interface and of second information which is to be presented to the user via second output means of the multi-modal interface, the system including processing means configured to:

estimate the total time needed to deliver the first information to the first output means or to a store local to the first output means;

estimate the total time needed to deliver the second information to second output means or to a store local to the second output means; and

to use the estimates obtained to determine whether the presentation to the user of the first or second information to the user needs to be delayed to achieve a desired synchronism of presentation; and to cause any delay determined to be necessary to be applied to achieve the desired synchronism of presentation.

In a fifth aspect the invention provides a system of apparatus for the delivery to a user of first information which is to be presented to the user via a visual display of a multi-modal interface and of second information which is to be presented to the user over a visual or an audio interface of the multi-modal interface, the system including processing means configured to:

estimate the total time needed to deliver the first information to the visual display or to a store local to the visual display;

estimate the total time needed to deliver the second information to the visual or audio interface or to a store local to the visual or audio interface; and

to use the estimates obtained to determine whether the presentation to the user of the first or second information to the user needs to be delayed to achieve a desired synchronism of presentation; and to cause any delay determined to be necessary to be applied to achieve the desired synchronism of presentation.

The invention will now be described, by way of example only, with reference to the accompanying drawings in which:

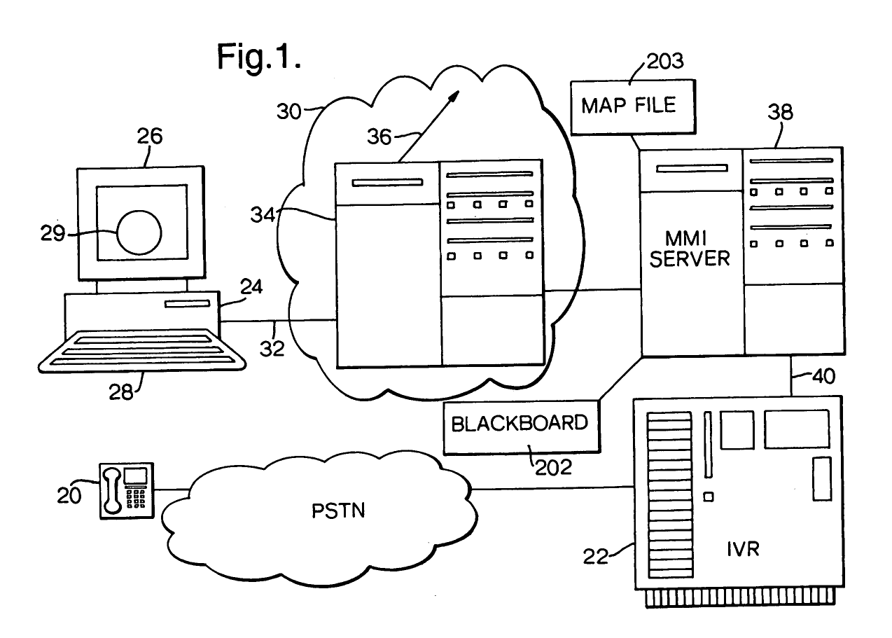

FIG. 1 is a schematic diagram showing equipment to provide a multi-modal interface;

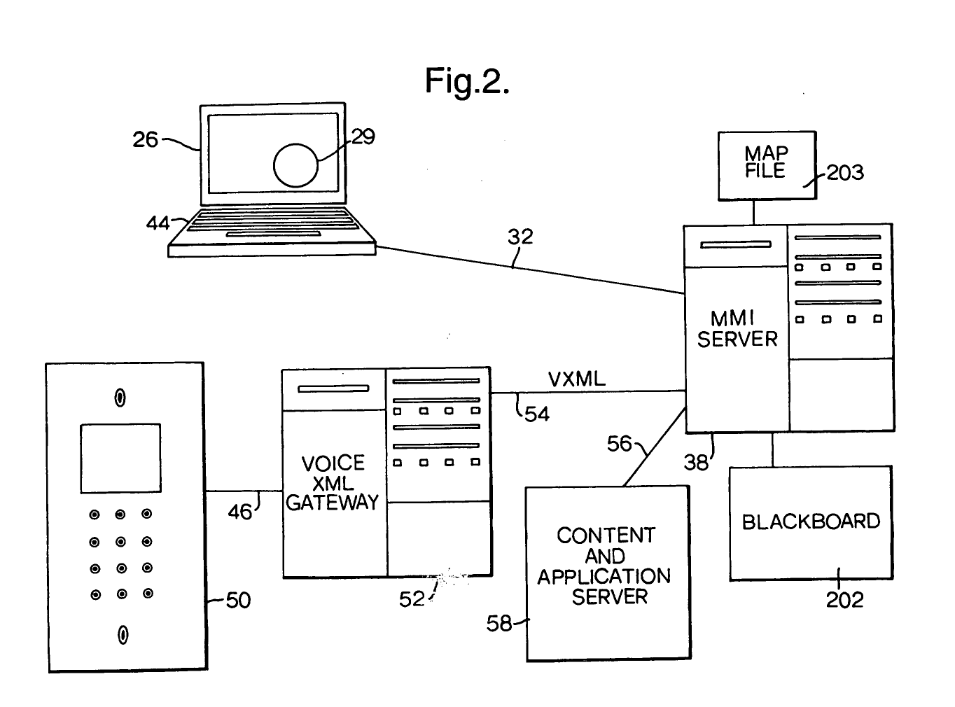

FIG. 2 shows schematically an alternative system of hardware to provide a multi-modal interface; and

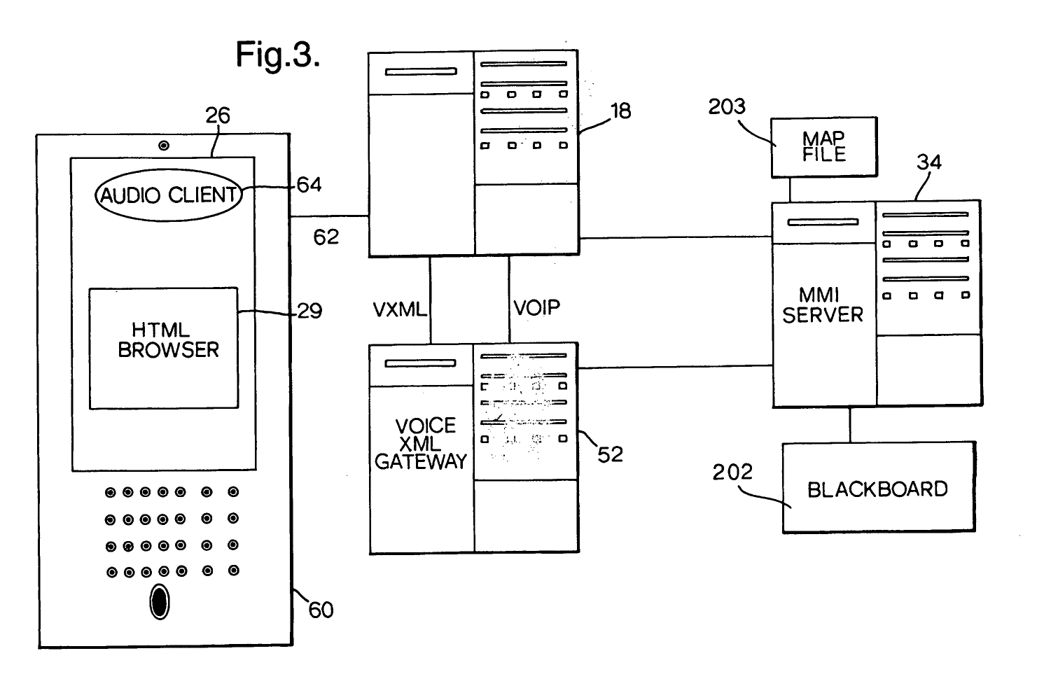

FIG. 3 shows schematically a further system of hardware to provide a multi-modal interface.

### SPECIFIC DESCRIPTION

Before describing and explaining the invention it is necessary for the reader to have some understanding of the context of the invention. To this end, FIG. 1 shows an example of a system set up to provide a multi-modal interface. This will now be described as an introduction to the invention. It should be noted however that the invention is not restricted in its application to systems of the type shown in FIG. 1.

FIG. 1 shows a basic system on which the invention can be implemented. The system includes a telephone 20 which is connected, in this case, over the public switched telephone network (PSTN) to a VoiceXML based interactive voice response unit (IVR) 22. The telephone 20 is co-located with a conventional computer 24 which includes a VDU 26 and a keyboard 28. The computer also includes a memory holding program code for an HTML web browser, such as Netscape Navigator or Microsoft's internet Explorer, 29, and a modem or network card (neither shown) through which the computer can access the Internet (shown schematically as cloud 30) over communications link 32. The internet 30 includes a server 34 which has a link 36 to other servers and computers in the internet. Both the IVR unit 22 and the internet server 34 are connected to a further server 38 which we will term a synchronisation server. Note that IVR unit 22, internet server 34 and synchronisation server may reside on the same hardware server or may be distributed across different machines.

In the example shown a user has given a URL to the HTML browser, the process of which is running on the computer 24, to direct the browser 29 to the web-site of the user's bank. The user is interested in finding out what mortgage products are available, how they compare one with another and which one is most likely to meet his needs. All this information is theoretically available to the user using just the HTML browser 29, although with such a uni-modal interface data entry can be quite time consuming. In addition, navigating around the bank's web-site and then navigating between the various layers of the mortgage section of the web-site can be particularly slow. It is also slow or difficult to jump between different options within the mortgage section. This is particularly true because mortgage products are introduced, modified and dropped fairly rapidly in response to changing market conditions and in particular in response to the offerings of competitors. So the web site may be subject to fairly frequent design changes, making familiarisation more difficult. In order to improve the ease of use of the system there is provided a multi-modal interface through the provision of a dial-up IVR facility 22 which is linked to the web-site hosted by the server 34. The link between the IVR facility 22 and the server 34 is through the synchronisation manager 38.

The web-site can function conventionally for use with a conventional graphical interface (such as that provided by Navigator or internet Explorer when run on a conventional personal computer and viewed through a conventional screen of reasonable size and good resolution). However, users are offered the additional IVR facility 22 so that they can have a multi-modal interface. The provision of such interfaces has been shown to improve the effectiveness and efficiency of an internet site and so is a desirable adjunct to such a site.

The user begins a conventional internet session by entering the URL of the web-site into the HTML browser 29. The welcome page of the web-site may initially offer the option of a multi-modal session, or this may only be offered after some security issues have been dealt with and when the user has moved from the welcome page to a secure page after some form of log-in.

In this example the web-site welcome page asks the user to activate a “button” on screen (by moving the cursor of the graphical user interface (GUI) on to the button and then “clicking” the relevant cursor control button on the pointing device or keyboard) if they wish to use the multi-modal interface. Once this is done, a new page appears showing the relevant telephone number to dial and giving a PIN (e.g. 007362436) and/or control word (e.g. swordfish) which the user must speak when so prompted by the IVR system 22. The combination of the PIN or control word and the access telephone number will be unique to the particular internet session in which the user is involved. The PIN or password may be set to expire within five or ten minutes of being issued. If the user delays setting up the multi-modal session to such an extent that the password has expired, then the user needs to re-click on the button to generate another password and/or PIN.

Alternatively this dialling information may included in the first content page rather than as a separate page.

Alternatively if the user was required to login to the website then the ‘click’ may result in the IVR system making an outbound call to the user at a pre-registered telephone number.

In addition the welcome page may include client side components of the synchronisation manager which are responsible for detecting user interface changes (e.g. changes in the form field focus or value) in the Visual browser and transmitting these to the synchronisation manager, as well as receiving messages from the synchronisation manager which contain instructions on how to influence the user interface (e.g., moving to a particular form filed, or changing a form field's value)

In addition when providing this page the synchronisation manager provides the web browser with a session identifier which will be used in all subsequent messages between the synchronisation manager and the web browser or client components downloaded or pre-installed on the web browser.

In the case where the user calls the IVR system, using the telephone 20, the user is required to enter, at the voice prompt, the relevant associated items of information which will generally be the user's name plus the PIN or password (if only one of these is issued) or to enter the PIN and password (if both are issued by the system) in which case entry of the user's name will be in general not be needed (but may still be used). Although the PIN, if used, could be entered using DTMF signalling, for example, it is preferred that entry of all the relevant items of information be achieved with the user's voice. The IVR system will typically offer confirmation of the entries made (e.g. by asking “Did you say 007362436?” or “Did you say swordfish?”), although this may not be necessary if the confidence of recognition of all the items is high. Once the IVR system has received the necessary data, plus confirmation, if required, it sends a call over the data link 40 to the synchronisation manager 38 and provides the synchronisation manager 38 with the PIN, password and/or user name as appropriate. The synchronisation manager 38 then determines whether or not it has a record of a web session for which the data supplied by the IVR system are appropriate. If the synchronisation manager 38 determines that the identification data are appropriate it sends a message to both the IVR system 22 informing it of the current voice dialogue to be run by the IVR and providing the IVR with a session identifier which is used by the IVR application when making subsequent information requests and data updates to the synchronisation manager. The initial dialogue presented by the IVR system 22 may also provide voiced confirmation to the user that the attempt to open the multi-modal interface has been successful. Preferably the web server 38 also sends confirmation to the computer 24, typically via a new HTML page, which is displayed on screen 26, so that the user knows that the attempts to open the multi-modal interface has been successful.

At this point, either or both of the IVR system 22 and the web server 38 can be used to give the user options for further courses of action. In general it is more effective to give the user a visual display of the (main) options available, rather than the IVR system 22 providing a voiced output listing the options. This is because visual display makes possible a parallel or simultaneous display of all the relevant options and this is easier for a user (particularly one new to the system) to deal with than the serial listing of many options which a speech interface provides. However, an habituated user can be expected to know the option which it is desired to select. In this case, with a suitably configured IVR system, preferably with “barge in” (i.e., the ability for the system to understand and respond to user inputs spoken over the prompts which are voiced by the IVR system itself), and appropriately structured dialogues, the user can cut through many levels of dialogue or many layers (pages) of a visual display. So for example, the user may be given an open question as an initial prompt, such as “how can we help?” or “what products are you interested in?”. In this example an habituated user might respond to such a prompt with “fixed-rate, flexible mortgages”. The IVR system recognises the three items of information in this input and this forces the dialogue of the IVR system to change to the dialogue page which concerns fixed-rate flexible mortgages. The IVR system requests this new dialogue page via the synchronisation server 38 using data link 40. Also, if the fact that the dialogue is at the particular new page does not already imply “fixed-rate, flexible mortgages” any additional information contained in that statement is also sent by the IVR system to the synchronisation server 38 as part of the request.

The synchronisation server 38 uses the session identifier to locate the application group that the requesting IVR application belongs to and using the mapping means converts the requested voice dialogue page to the appropriate HTML page to be displayed by the Web browser. A message is then sent to the Web Browser 29 instructing it to load the HTML page corresponding to Fixed rate mortgages from the web server 34 via the synchronisation manager 38 using data link 20. In this way both the voice browser and the web browser are kept in synchronisation “displaying” the correct page.

The fixed rate mortgage visual and voice pages may include a form containing one or more input fields. For example drop down boxes, check boxes, radio buttons or voice menus, voice grammars or DTMF grammars. The voice browser and the visual browser execute their respective user interface as described by the HTML or VoiceXML page. In the case of the Visual browser this means the user may change the value of any of the input fields either by selecting from e.g. the drop down list or typing into a text box, for the voice browser the user is typically led sequentially through each input field in an order determined by the application developer, although it is also possible that the voice page is a mixed initiative page allowing the user to fill in input fields in any order.

The user selects an input field either explicitly e.g. by clicking in a text box or implicitly as in the case of the voice dialog stepping to the next input field according to the sequence determined by the application developer. Then the client code components of the Synchronisation manager send messages to the synchronisation manager indicating that the current ‘focus’ input field has changed. This may or may not cause the focus to be altered in the other browsers, depending on the configuration of the synchronisation manager. If the focus needs to change in another browser then a message is sent from the synchronisation manager to the client component in the other browser to indicate that the focus should be changed. For example if the voice dialog asks the question “How much do you want to borrow” then the voice dialogue will indicate that the voice focus is currently on the capital amount field. If so configured then the synchronisation manager will map this focus to the corresponding input element in the visual browser and will send a message to the visual browser to set the focus to the capital amount field within the HTML page, this may result in a visible change in the user interface, for example the background colour of the input element changing to indicate that this element now has focus. If the user then responds “80,000 pounds” to the voice dialogue then the input is detected by the client component resident in the voice browser and transmitted to the synchronisation manager. The synchronisation manager determines whether there is a corresponding input element in the HTML page, performs any conversion on the value (e.g. 80,000 pounds may correspond to index 3 of a drop down list of options 50,000 60,000 70,000 80,000) and sends a message to the client component in the HTML browser instructing it to change the html input field appropriately. In parallel the user may also have clicked on the check box in the HTML page indicating that a repayment mortgage is preferred, this change in value of the input field is transmitted via the synchronisation manager to the voice browser client components which modify the value of the voice dialog field corresponding to mortgage type such that the voice dialogue will now skip the question “Do you want a repayment mortgage?” since this has already been answered by the user through the HTML interface. Hence it can be seen that the combination of the client side components and the synchronisation manager enable user inputs that affect the values of input elements of a form within an HTML or voiceXML page are kept in synchronisation.

More typically, the fixed-line telephone 20 of the FIG. 1 arrangement will be replaced with a mobile telephone, smart phone or PDA with a cellular radio interface (GSM, GPRS or UMTS). Similarly, the conventional computer 24 with a wired interface will be replaced with a lap top or palm top computer with a wired or wireless (infra red, Bluetooth, or cellular) interface. Examples of such alternative configurations are shown in FIGS. 2 and 3.

In FIG. 2 a laptop computer 44 runs an HTML browser process 29, the GUI of which is visible on screen 26. The laptop is connected via a wireless data link 32 (such as a wireless LAN) to synchronisation server 38. The user of the laptop 44 also has a cellular telephone 50 which is connected via a GSM link 46 (of a cellular network) to a voice XML gateway 52. The gateway 52 is connected via a VXML channel 54 to the synchronisation server 38. The synchronisation server 38 is linked to a content and application server 58 from which content and application programs may be downloaded to either the mobile phone 50 or the laptop 44. The multi-modal interface process which is controlled by the synchronisation server 38 makes use of a blackboard (data store) 202 in the process of passing data updates between the various application programs (e.g. the HTML browser 29 and the Voice XML browser of the gateway 52) which make up the interface. The map file 203 is used by the synchronisation server 38 to ensure appropriate synchronisation between the browsers.

In FIG. 3 a smart phone 60 (or PDA with an appropriate mobile-telephony interface) replaces the separate display and telephone of the examples of FIGS. 1 and 2. The smart phone 60 runs an HTML browser 29 and an audio client 64. These communicate via a wireless link with a synchronisation server 38.

The invention concerns techniques for ensuring that the visual components of the multi-modal interface, which will be displayed by means of the VDU 26, are available to the user at an appropriate time with respect to the audio components, which are provided over the telephone 20.

Various factors may need to be taken into account if the various information components are to be delivered with appropriate timing. Many of these are system specific and these will not be considered here in detail here. Examples are:

how long a browser takes to render (visually or whatever) the content;

whether the content is dynamically generated (and how long generation takes—perhaps there's database access that slows it down);

how error-prone the connection is (possibly necessitating unforeseen resend attempts);

If a network-based voice browser is being used, it may well be supporting multiple users (loading the CPU more), in which case it will be slower to ‘render’ the pages once they have arrived; and

some types of content (Java applets, for example) may, once delivered, take significant time to ‘start up’ or display.

There are three generic factors which may more often fail to be considered and they are network latency, network bandwidth and total document size. Methods of calculating these will now be described in turn below.

### Estmating Network Latency

The latency is a measure of the total time taken for data to travel from one part of the network to another. Usually, this will be quite small, but is potentially of the order of seconds. Since clients may be located on different networks, this becomes an important consideration. A method is suggested for the estimation of network latency for each client, requiring no additional client software. This method also allows the difference between server and client clocks to be estimated. Once this is known, client requests to the server can be more accurately time stamped, thereby giving a revised estimate of the latency.

In the following description, times without a prime (′) are server times, and times with a prime are equivalent client times. Thus, the client's clock reads T₂′ when the server's clock reads T₂.

1. The client opens a connection to the server by requesting a specific page that is generated by a servlet;

2. At time T₁ the server returns a very small document to the client using the open connection;

3. Some time later, at time T₂, the client receives the document and immediately sends it back with its own current time T₂′ attached;

4. The packet arrives back at the server at time T₃.

The server can then calculate, at leisure, the approximate network latency and the approximate difference in the clock times:
latency≅½(T₃−T₁)
and:
T₂′ +adjustment =T₂
adjacent =T₂—T₂′
aijustnentz -i +latenc—T₂′
adjustrnent- T₁ +′/2( T3—T₁)—T₂′
adjustanent—1/2( T₃ +T.)—T₂′

When the client makes future requests to the server, it can time-stamp them r +adjustment, which will approximate to T, the server's time when the client's clock reads T′.

Implementation of Network Latency Estimation

Three methods are proposed, all based upon HTML browsers, one of which can be used with a stand-alone Java-based browser, and one of which calculates latency but does not allow the difference between the client's and server's clocks to be estimated and the latency re-estimated.

Note that for all three systems, the described implementation uses dedicated URLs to perform the latency estimation. It is reasonable to assume that the server could return appropriate synchronisation code in response to any request made by the client, before returning the actual page requested, thereby removing the need for a specialised URL.

(I) HTML-Based Method

For HTML browsers that do not support the use of Java applets or JavaScript, an HTML-based method is suggested. The method, which does not allow the clock difference measurement, is as follows:

1. The client makes a GET request to the server, indicating that it is ready to cooperate in estimating the latency (for example, http://www.myserver.com/servlet/CalculateLatency).

2. The server, at leisure, returns an HTML document that immediately loads another HTML document from the same server. For example: <html><meta http-equiv=“refresh” content=“0; URL=http://www.myserver.com/servlet/CalculateLatency?time=1002718472800”></html>

3. The server, again at leisure, can then estimate the latency of the connection based upon the time between sending the first document and receiving the request for the second.

(II) HTML- and JavaScript-Based Method

For HTML browsers that support JavaScript but not Java, an HTML- and JavaScript-based method can be used instead. This allows the approximate difference between the client's and server's clock to be calculated, thereby enabling the latency estimate to be updated on each subsequent request to the server. The method is as follows:

1. The client makes a GET request to the server, indicating that it is ready to cooperate in estimating the latency.

2. The server, at leisure, returns an HTML document containing JavaScript that immediately loads another HTML document from the same server. For example: <html><script language=“JavaScript”><!—self.location=“http://www.myserver.com/servlet/CalculateLatency?stime=1002718472800&ctime=”+(new Date( )).getTIme( ); //--></script></html>

3. The server, again at leisure, can then estimate the latency of the connection based upon the time between sending the first document and receiving the request for the second.

4. The server can also estimate the difference between the dient's and server's clocks using the latency (all times are by the server's clock unless otherwise stated):
T₁ is the time at which the server sends the first document;
T₂ is the time at which the client receives the response and begins loading the second document;
T₃ is the time at which the server receives the request for the second document;
T₂′ is the time by the client's dock at the same instant that the server's dock reads T₂.

$${T}_{2}^{′} + adjustment = {T}_{2}$$

$$\begin{matrix}adjustment = {T}_{1} + latency - {T}_{2}^{′} \\ = {T}_{1} + 1 / 2 ( {T}_{3} - {T}_{1} ) - {T}_{2}^{′} \\ = 1 / 2 ( {T}_{3} + {T}_{1} ) - {T}_{2}^{′}\end{matrix}$$

and T₃, T₁ and T₂′ are known by the server. Knowledge of the clocks' difference means that when the client makes future requests to the server, it can time-stamp them T′+adjustment, which will approximate to T, the server's time when the client's clock reads r, thus enabling the latency to be recalculated. This will provide an effective re-estimation under the condition that the latency may have changed, but is always the same in both directions on the channel.

(III) Java-Based Method

This exploits Java's greater control over POST requests to the server, opening what is in essence the second connection before it is actually needed. This also allows the difference between the two clocks to be estimated, and the process is:

1. The client makes a POST request to the server, but does not send any of the POST information yet.

2. The client makes a GET request to the server, indicating that it is ready to cooperate in estimating the latency.

3. The server, at leisure, returns a text document containing its current time.

4. This is immediately parsed by the client, which then straight away completes its previously-opened POST by sending the client's current time and the time received from the server.

5. The server, again at leisure, can then estimate the latency of the connection based upon the time between sending the first document and receiving the request for the second.

6. The server also estimates the difference between the client's and server's clocks using the latency as explained above.

While all of these techniques to focus on the latency of the channel for the visual content, similar techniques can be used with Voice XML for speech content. Where Voice XML is not used other techniques can be adopted to obtain the relevant information.

Where two channels are known to have similar characteristics (at least in so far as latency is concerned), the latency calculated for one of the channels may be used to delay content on the other channel. Similar channels might be associated with two modes on the same multi-modal sessions, or even two modes in different sessions. This extension proves useful when clients are known to share similar channel characteristics, but one client is not capable of co-operating in the latency estimation procedure: in this case, the latency calculated through the more capable browser (or whatever) can be used to determine the treatment (e.g. delay or not relative to another channel) appropriate for the channel with the less capable browser (or whatever).

### Estimating Network Bandwidth

The bandwidth of each network is calculated by the server, which records the total time taken to send a file to the client, then uses that and the size of the file to estimate the average bandwidth. Since multiple downloads can occur simultaneously, the server must be aware of downloads occurring at the same time as the one being measured. All downloads must be through the server for an accurate estimation of the bandwidth. Since the server is aware of what files it is uploading to what client, and when each upload starts and stops, the effective upload time can be calculated. Take the following example of four files being uploaded to the same client:

[image]

The horizontal axis represents time, and each arrow indicates the time period in which that file downloads. Taking FILE 1 as an example, the total upload time is a+b+c+d+e+f. However, at various times, more than one file is being uploaded to the client at once. Making the assumption that all uploads have the same priority and therefore the same approximate proportion of total available bandwidth, the effective upload time for FILE 1 is a+b/2+c/3+d/4+e/3+f/2. A similar approach is used for all uploads, yielding an approximation of the bandwidth.

Implementation of Network Bandwidth Estimation

A Java-based system has been developed to estimate the bandwidth of the network. All requests to the server are performed via servlets: simple requests are wrapped in a small-footprint servlet; servlet requests have additional logic. The system works by creating a single instance of a class that maintains information on current and historical downloads. Every request to the server causes—by virtue of the aforementioned wrapper or additional logic—a method call on this object that logs the download. When the download completes, a similar call is made to cause the bandwidth to be recalculated.

In order to follow any changes in bandwidth, a limited-size history is maintained so that only the last N downloads' bandwidth calculations are included in the overall bandwidth estimation, which is essentially a running average. Before any requests are accepted, various data have to be prepared, including:
A lookup table to associate execution thread IDs with download start times.
A variable-size array to store information about each download start/finish event.

When a call is made to indicate that a download is starting, the sequence of events is:

1. Get the current time in milliseconds.

2. Append an entry to the array to store the time and the [increased] number of downloads.

3. Add the execution thread's ID to the lookup table so its start time can be determined when its download has finished.

When a call is made to indicate that a download is finishing, the sequence of events is:

1. Get the current time in milliseconds.

2. Append an entry to the array to store the time and the [decreased] number of downloads.

3. Get the start time from the lookup table, based upon the thread's ID.

4. Calculate the bandwidth based upon this single download (see below for details).

5. Update the running average of the bandwidth

It is perhaps easiest to explain how the bandwidth is calculated for a single download by means of an example. The following table represents the array containing the download start/finish events:

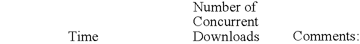

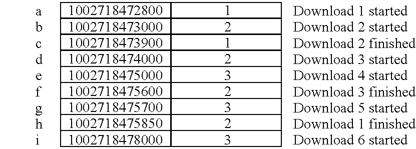

The lone-download time (i.e., the total time it would have taken to download if there were no concurrent downloads) for Download 1 is given by the sum of the times between successive entries divided by the number of downloads in progress at that time. In other words, this is:

$$( 1002718473000 - 1002718472800 ) + 1 + \\ ( 1002718473900 - 1002718473000 ) + 2 + \\ ( 1002718474000 - 1002718473900 ) + 1 + \\ ( 1002718475000 - ( 1002718474000 ) + 2 + \\ ( 1002718475600 - ( 1002718475000 ) + 3 + \\ ( 1002718475700 - ( 1002718475600 ) + 2 + \\ ( 1002718475850 - ( 1002718475700 ) + 3 \\ = 200 + 450 + 100 + 500 + 200 + 50 + 50 \\ = 1550 ms$$

The size of the document being downloaded from the server to the client can either be retrieved from the server (by, for example, using the getContentLength( ) method of Java's URLConnection class) or, for dynamic documents, can be calculated by storing the document being generated and writing it out once its length is known.

Thus, the effective bandwidth for the duration of this document's download can be calculated by dividing the size by the lone-download time.

Each document being uploaded from the server to the client is parsed to determine which other documents (images, grammars, or frames, for example) are also automatically uploaded at the same time. Knowledge of the client's caching policy is required (Including what inline content is automatically downloaded and which not), as is the initial state of its cache (most probably empty). As the server finds these additional documents, it maintains a total of the amount of data the must be sent to the client, based upon its knowledge of the client's cache. For example, a file that is not in the cache or which has expired will have its size added to the total; but one that is present in the cache but has not expired will not have its size added. As necessary, these other documents are also parsed recursively. An example of this might be when a frameset is being downloaded:

each enclosed frame may also need to be downloaded, along with its images and sound files, etc. . .

### Implementation of Total Document Size

Once the approximate bandwidth between server and client is known, the time it will take to download the document and its sub-documents (including images, grammar files, non-streaming audio or video files, and child frames and their sub-documents) needs to be calculated. As already explained, it is necessary to be able to guarantee one of two things to yield a successful estimate of total download time: (a) that the initial document has no sub-documents; or (b) that the caching policy of the client browser is known, as well as the initial state of the cache. In the first case, the total document size is the same as the initial document's size; the calculation is therefore trivial. In the second case, the server is able to determine which of the sub-documents will need to be downloaded by the client and which will not; calculation is essentially quite straightforward, as the following steps that the server will need to take demonstrate:

1. Parse the initial document and determine what sub-documents it contains. Depending upon the complexity of the document, this task could range from very easy (as with a VoiceXML document containing grammars that are always—i.e., not dynamically—loaded) to very difficult (as with an applet that downloads various images, sound files, and Java classes; or as with an HTML document containing JavaScript that dynamically writes some of the HTML).

2. For each of the sub-documents, determine from its type whether it is inherently stand-alone (such as an image) or whether it, like the initial document, contains other sub-documents to download (such as a frame with the initial document's frameset), then parse that according to step 1 as necessary.

3. Repeat steps 1 and 2 until a list of all documents has been constructed.

4. Based upon prior knowledge of the client's cache and caching policy, remove from the list all documents that the client will not need to download (because they are cached and are not expired).

5. Calculate the total download size by summing the individual size of each document still in the list.

For the purposes of this implementation, only relatively simple documents will be parsed in step 1. Dynamic documents are not covered by this implementation; however, it is clear that a full browser would be necessary to parse some of the more complex documents. A possible implementation would be a proxy client, local to the server, that sits between the server and the client. This would mirror the actual client, downloading pages from the server and passing them as a proxy to the remote client. The proxy client would have an identical caching policy to the actual client (which would need its cache aligned with the proxy's, most likely by clearing it) and would be in direct link with the server. In this way, the server does not need to calculate the amount of data that will be downloaded to the client, instead delivering it rapidly to the proxy client and summing the amount of data it delivers.

The overall implementation described in this document also covers the trivial, no-sub-document case mentioned above.

### Delaying the Content

Once these three factors (network latency, network bandwidth and total document size) are known (along with implementation-specific factors as mentioned above), an estimate of the total time to deliver the content can be calculated for each client based upon its own network characteristics. The difference between the longest of these download times and each of the others can then be used as a delay. For example, if the longest of the clients' download times is 10 seconds, that client's content will be delivered as quickly as possible (i.e., with no delay). If another client's download time is 6 seconds, that client's content can be delayed (by the server) by 4 seconds to ensure that it finishes downloading at the same time as the first client. Of course, in some situations it may be known that network latency, for example, is the dominant factor (e.g. where network bandwidth is high and total document size is not significant). In such a situation network latency may be the only factor which needs to be taken into account when estimating the total delivery time.

Usually the estimation of download times and any addition of delay will be performed automatically under the control of the multi-modal interface process.

### Alternatives to Delaying Content Delivery

Instead of simply delaying content, another, more user-friendly approach is to deliver a pre-content “page” to all but the longest-download client, saying roughly how long the full content will take to download or specifying the time, T′, at which the content should be delivered (using the timing estimates from above).

Another approach is to only delay content when it absolutely has to be delivered at the same time. An example might be when an audio client says “please speak one of the options on your screen”; it must not say this before the visual client has finished loading. A further approach, only possible in some systems (such as described GB 0108044.9 Agent's Ref. A26127), is to use an event mechanism whereby each client sends a message to the server, then waits for a response telling it to “display” (in whatever way) the content. The server waits for all clients (or an appropriate, minimal, or predetermined selection of clients) to indicate that they have finished loading before informing the clients that they can commence “display”. (In an HTML browser, this could be achieved by using the document's/frameset's onload event, then loading a specific URL into a JavaScript image object and using that object's onload event to activate the page. The server would not reply to the ‘image’ URL request until the right selection of clients were ready.)

The foregoing description has primarily focussed on systems in which audible content is delayed so that it does not arrive before the related visual content. The delay may be chosen so that the audible content is delivered at the same moment as the visual information or, as is more usual, the delay may simply be such that the visual information has been displayed and is visible to the user before (often just before) the audible content is delivered. Of course this latter may require that it is the visual content which is delayed in order to be presented to the user just before or simultaneously with the audible content, where the visual content would otherwise arrive too soon before the audible content. The application developer may delay other content in the same way, in particular, visual content from two different sources or systems may need to be synchronised so that the correction of timing to achieve synchronisation may be of one quantum of visual content with respect to another quantum of visual content (with or without an related audible content). Another example where synchronisation could be of value, and hence where the invention could be applied is in synchronising WML and HTML (for example in using a WAP phone to control an HTML browser in a shop window, so the HTML browser is effectively improving the graphical capabilities of the WAP phone). Another use case is synchronising two voice browsers, each in a different language, so that two people of different nationalities could work together to complete a form. A further example is the synchronisation of a voice interface (e.g. a voice browser) with a tactile (or haptic) interface such as a Braille terminal, so that a blind person can benefit from multi-modality, much as a sighted person does when using visual and audible interfaces.”

The application developer may also specify the degree of synchronisation by indicating the maximum allowable delay between the arrival of different content for it to be considered simultaneous. The described process can be applied to any combination of any number of modes, and it is the application developer's decision which of these are delayed to arrive simultaneously or synchronously.

The invention has been described in the context of content synchronisation in multi-modal interfaces. The principles behind the invention extend beyond multi-modal interfaces and may, for example, be used to good effect for the synchronisation of clients for more than one person, such as two (or more) people in separate locations viewing the same web page together, when the synchronisation would be of the web browsers of the two (or more) users.

1. A method of synchronising the delivery to a user of first information which is to be presented to the user via first output means of a multi-modal interface arid of second information which is to be presented to the user via second output means of the multi-modal interface, the method comprising the steps of:
i) estimating the total time needed to deliver the first information to the first output means or to a store local to the first output means;
ii) estimating the total time needed to deliver the second information to the second output means or to a store local to the second output means; and
iii) using the estimates obtained in step i) or step ii) to determine whether the presentation to the user of the first or second information to the user needs to be delayed to achieve a desired synchronism of presentation; and
iv) applying any delay determined in step iii) to achieved the desired synchronism of presentation.

2. A method as claimed in claim 1, wherein the first and second output means are provided by a single output device.

3. A method as claimed in claim 1, wherein either or both of the first and second output means is/are visual display means.

4. A method as claimed in claim 1, wherein either or both of the first and second output means is/are audio reproduction means.

5. A method as claimed in claim 1, wherein either or both of the first and second output means is/are tactile reproduction means.

6. A method as claimed in claim 1, wherein the first means is visual display means and the second means is audio reproduction means.

7. A method of synchronising the delivery to a user of first information which is to be presented to the user via a visual display of a multi-modal interface and of second information which is to be presented to the user over a visual or an audio interface of the multi-modal interface, the method comprising the steps of:
i) estimating the total time needed to deliver the first information to the visual display or to a store local to the visual display;
ii) estimating the total time needed to deliver the second information to the visual or audio interface or to a store local to the visual or audio interface; and
iii) using the estimates obtained in step i) or step ii) to determine whether the presentation to the user of the first or second information to the user needs to be delayed to achieve a desired synchronism of presentation; and
vi) applying any delay determined in step iii) to achieved the desired synchronism of presentation.

8. A method of synchronising the delivery to a user of first information which is to be presented to the user via a visual display of a multi-modal interface and of second information which is to be presented to the user over an audio interface of the multi-modal interface, the method comprising the steps of:
i) estimating the total time needed to deliver the first information to the visual display or to a store local to the visual display;
ii) estimating the total time needed to deliver the second information to the audio interface or to a store local to the audio interface; and
iii) if the total time estimated in step i) is more than that estimated in step ii) delaying the presentation of the second information to the user sufficiently to enable the first information to be presented to the user before the second information is presented to the user.

9. A method as claimed in claim 7, wherein the delivery of the first information in step (i) is controlled by a server process, delivery of the first information involving delivery of that information to a client of the server process.

10. A method as claimed in claim 7, wherein the delivery of the second information in step (ii) is controlled by a server process, delivery of the second information involving delivery of that information to a client of the server process.

11. A method as claimed in claim 7, wherein the latency of the communication channel over which the first information will be delivered to visual display or the store is measured, the measurement of latency being used in the estimation of total time carried out in step (i).

12. A method as claimed in claim 7, wherein the latency of the communications channel over which the second information will be delivered to the audio interface or to the store local to the audio interface is measured, the measurement of latency being used in the estimation of total time carried out in step (ii).

13. A method as claimed in claim 11, wherein the measurement of latency involves the server process sending a communication to the associated client to elicit a response therefrom, the measurement of latency being derived from the duration of the interval between the sending of the communication and the receipt of the response.

14. A method as claimed in claim 7, wherein knowledge of the quantity of first information which is to be presented and knowledge of the bandwidth of the communication channel over which the first information will be delivered to the visual display or the store local to the visual display are used to calculate the time required to transmit the first information to the visual display or the local store which is subsequently used in the estimation carried out in step i).

15. A method as claimed in claim 7, wherein knowledge of the quantity of second information which is to be presented and knowledge of the bandwidth of the communication channel over which the second information will be delivered to the visual display or audio interface or local store are used to calculate the time required to transmit the second information to the visual display or audio interface or local store which is subsequently used in the estimation carried out in step ii).

16. A method as claimed in claim 7, wherein the estimate of total time produced in step i) includes a component for the time taken to render the first information on the visual display.

17. A method as claimed in claim 7, wherein the estimate of the total time needed to deliver the first content is based, at least in part, upon one or more characteristics of the communications channel over which the second information is delivered, or wherein the estimate of the total time needed to deliver the second content is based, at least in part, upon one or more of the characteristics of the communications channel over which the first information is delivered.

18. A method as claimed in claim 17, wherein the latency of the communications channel is a characteristic upon which the estimate is based.

19. A method as claimed in claim 16, wherein the bandwidth of the communications channel is a characteristic upon which the estimate is based

20. A system of apparatus for the delivery to a user of first information which is to be presented to the user via a visual display of a multi-modal interface and of second information which is to be presented to the user over a visual or an audio interface of the multi-modal interface, the system including processing means configured to:
estimate the total time needed to deliver the first information to the visual display or to a store local to the visual display;
estimate the total time needed to deliver the second information to the visual or audio interface or to a store local to the visual or audio interface; and
to use the estimates obtained to determine whether the presentation to the user of the first or second information to the user needs to be delayed to achieve a desired
synchronism of presentation; and to cause
any delay determined to be necessary to be applied to achieve the desired synchronism of presentation.

21. A system of apparatus for the delivery to a user of first information which is to be presented to the user via first output means of a multi-modal interface and of second information which is to be presented to the user via second output means of the multi-modal interface, the system including processing means configured to:
estimate the total time needed to deliver the first information to the first output means or to a store local to the first output means;
estimate the total time needed to deliver the second information to second output means or to a store local to the second output means; and
to use the estimates obtained to determine whether the presentation to the user of the first or second information to the user needs to be delayed to achieve a desired
synchronism of presentation; and to cause
any delay determined to be necessary to be applied to achieve the desired synchronism of presentation.
